(19) United States
(12) Patent Application Publication
(10) Pub. No.: US 2006/0147060 A1
(43) Pub. Date: Jul. 6, 2006

(54) Multifunction preamplifier microphone

(75) Inventors: Ching Shyu, San Jose, CA (US); Robert M. Khamashta, Los Gatos, CA (US); Robert J. Bernardi, Scotts Valley, CA (US)

Correspondence Address: PLANTRONICS, INC., 345 ENCINAL STREET, P.O. BOX 635, SANTA CRUZ, CA, 95060-0635, US

(73) Assignee: Plantronics, Inc. A DELAWARE CORPORATION, Santa Cruz, CA (US)

(21) Appl. No.: 11/026,846

(22) Filed: Dec. 30, 2004

(51) Int. Cl. H04R 3/00

(52) U.S. Cl. 381/113; 381/111

(57) ABSTRACT

Systems for a multifunction preamplifier microphone are disclosed. The system generally includes a microphone transducer and a configurable preamplifier circuit. The configurable preamplifier circuit includes an output terminal for outputting a signal, a configuration terminal for coupling one or more circuit components to the preamplifier circuit; and a housing containing the microphone transducer and configurable preamplifier circuit. Adjustable features include gain, frequency response and voice expansion timing characteristics.

### BACKGROUND OF THE INVENTION

Typically, the output of a microphone used in voice communications is received by a high input impedance pre-amplifier circuit. The pre-amplifier circuit may be used to amplify the signals before input into a second stage amplifier.

An electrical signal generated by a human voice may vary in signal strength depending on a variety of factors. The electrical signal output from the microphone may also include signal components resulting from wind and hum noise as well as radio frequency interference. Furthermore, the application in which the microphone is used may also affect the frequency characteristics of the electrical signal. For example, when used in varying types of headset designs, the electrical signal may have differing high frequency and low frequency characteristics.

Conventionally, microphone systems include a microphone element and a pre-amplifier circuit in a fixed configuration. The microphone system includes an output terminal in which the signal generated by the microphone element and amplified by the pre-amplifier is output. As a result, the pre-amplifier circuit may not be subsequently configured to selectively adjust the signal characteristics in the preamplifier stage. Thus there is a need for more flexible systems and methods for microphone systems.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified block diagram of a multifunction preamplifier microphone.

FIG. 2 illustrates a simplified detailed diagram of a circuit that implements the block diagram of FIG. 1.

FIG. 3 illustrates a simplified detailed diagram of a system utilizing the multifunction preamplifier microphone of FIG. 1.

FIG. 4 illustrates configuration of the multifunction preamplifier microphone in a test application to set a desired low pass frequency characteristic.

FIG. 5 illustrates configuration of the multifunction preamplifier microphone in a test application to set a desired high pass frequency characteristic.

FIG. 6 illustrates a simplified detailed diagram of a voice expansion timing circuit.

FIG. 7 illustrates a simplified diagram of input/output characteristics of the circuit illustrated in FIG. 6.

### DESCRIPTION OF SPECIFIC EMBODIMENTS

A configurable multifunction preamplifier microphone is disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Particular circuit layouts and circuit components may be given for illustrative purposes. This is done for illustrative purposes to facilitate understanding only, and one of ordinary skill in the art may vary the design and implementation parameters and still remain within the scope of the invention.

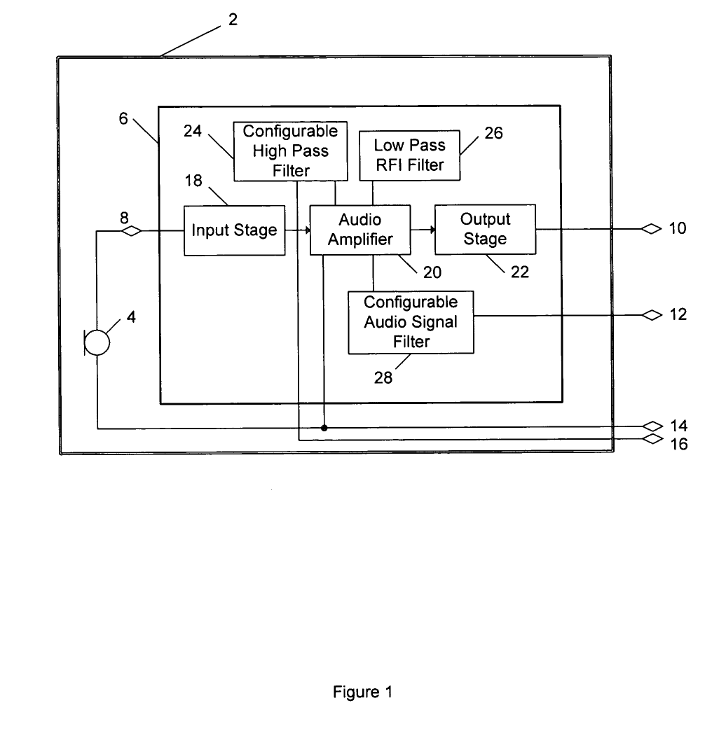

Generally, this description describes a multifunction preamplifier microphone. FIG. 1 illustrates a simplified block diagram of a multifunction preamplifier microphone 2 in one embodiment of the invention. Multifunction preamplifier microphone 2 is suitable for use, for example with a headset or other applications which require high output, high signal-to-noise ratio (SNR), flexible gain adjustment, radio frequency interference (RFI) filtering, and high pass and low pass filtering for audio signals.

Multifunction preamplifier microphone 2 generally includes a microphone transducer such as an electret condenser microphone element 4 and a circuit 6. Circuit 6 may, for example, be implemented on an application specific integrated circuit. Multifunction preamplifier microphone 2 may, for example, include a housing such as a microphone can containing the electret condenser microphone element 4 and the circuit 6. Circuit 6 may include an input stage 18, an audio amplifier 20, and an output stage 22. Additionally, circuit 6 includes circuitry for a configurable high pass filter 24 for low frequencies, a low pass radio frequency interference filter 26, and a configurable audio signal filter 28. Circuit 6 includes terminals 8, 10, 12, 14, and 16, which provide connection to various locations of circuit 6. Connections to terminals 10, 12, 14, 16, and other terminals described herein may extend outside the housing. Circuit 6 and electret condenser microphone element 4 include an appropriate connection via power supply conductors to a D.C. power supply. Terminal 14 may be coupled to ground.

Electret condenser microphone element 4 is typically a high source impedance, low voltage device which is coupled to input stage 18 via terminal 8. Input stage 18 has a high input impedance to prevent signal reduction at the input. The output of input stage 18 is provided to audio amplifier 20 which provides a signal gain. For example, audio amplifier may provide up to approximately 20 dB of gain. The signal is also processed by configurable high pass filter 24 for low frequencies, low pass RFI filter 26, and configurable audio signal filter 28 before being input to output stage 22. The output of output stage 22 is coupled to terminal 10 whereby the signal output from multifunction preamplifier microphone 2 is provided to additional circuitry coupled to terminal 10.

Configurable high pass filter 24 for low frequencies reduces low frequency hum noise resulting from AC power interference for headsets generally or wind noise resulting from wind in mobile headsets, problems known in the art. For example, configurable high pass filter 24 for low frequencies may have a 130 Hz cut-off frequency, providing 8 dB attenuation at 50 Hz for hum noise and 12 dB attenuation at 20 Hz for wind noise. Low pass RFI filter 26 reduces radio frequency interference in the signal. For example, low pass RFI filter 26 may have a corner frequency of 500 MHz for protecting headsets from RFI of 900 MHz or higher. In a further example, the corner frequency of low pass RFI filter 26 is configurable. Configurable audio signal filter 28 provides desired high pass, low pass, or bandpass filtering characteristics for audio signals. For example, the filtering characteristics may compensate for noise cancellation microphone or voice tube headset frequency characteristics. Circuit 6 may also have fewer or additional configurable or non-configurable filters or functional blocks than those illustrated in FIG. 1.

Configurable high pass filter 24 for low frequencies, low pass RFI filter 26, audio amplifier 20, and configurable audio signal filter 28 may function independently without additional circuitry or in conjunction with additional circuitry external to circuit 6 or multifunction preamplifier microphone 2. For example, additional circuit components coupled to terminal 16 may be utilized to configure the filter characteristics of configurable high pass filter 24 for low frequencies. Additional circuit components coupled to terminal 12 may be utilized to configure the filter characteristics of configurable audio signal filter 28. The use of two terminals 12 and 16 are merely for example, and fewer or a greater number of terminals may be used to allow configuration of circuit 6.

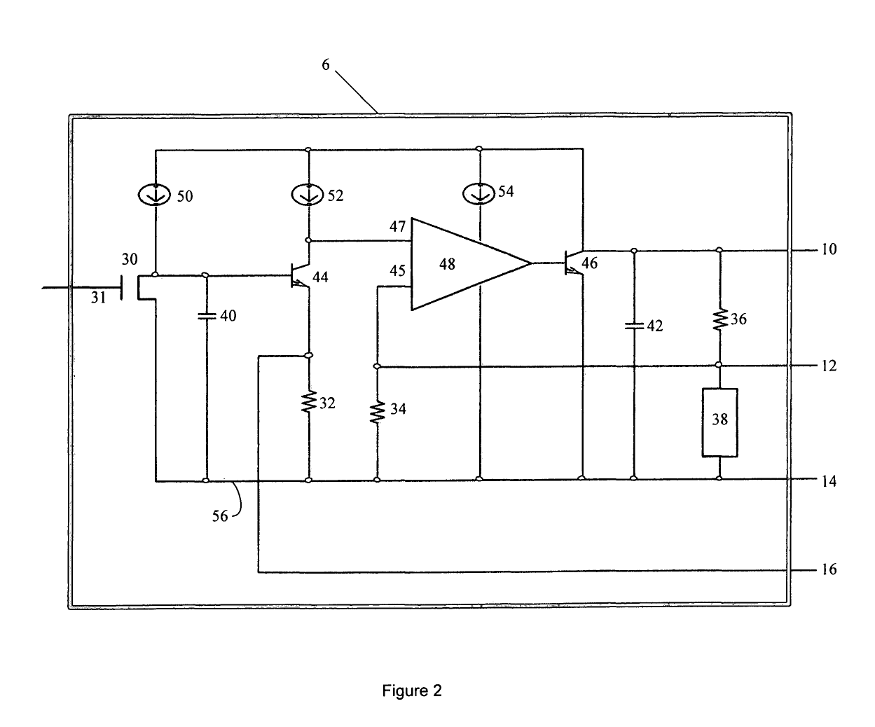

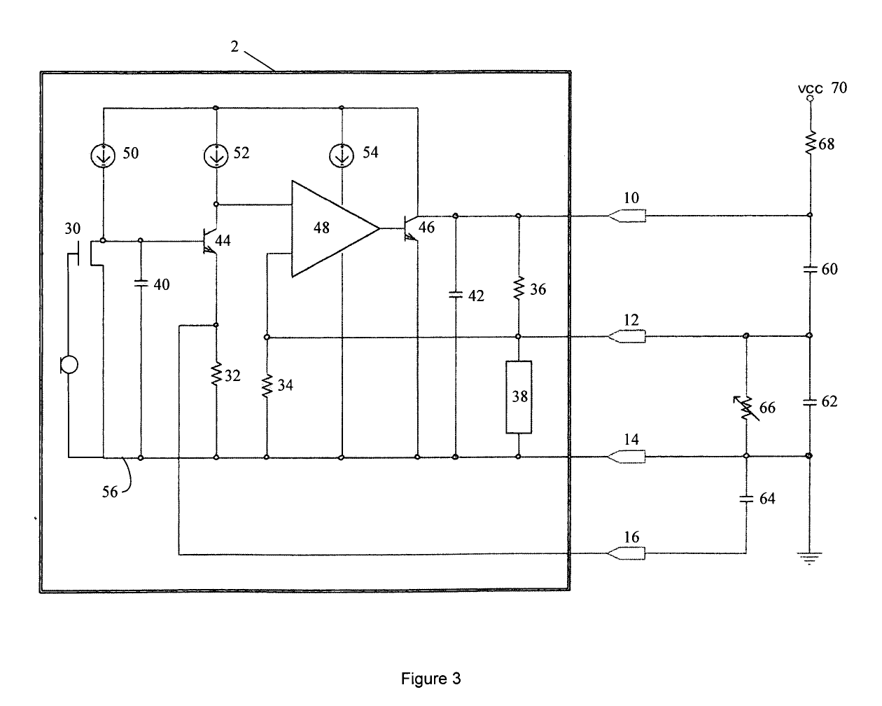

The basic operation of multifunction preamplifier microphone 2 can be considered on the basis of the block diagram illustration of FIG. 1. Achievement of some of the objectives of the invention can best be understood by consideration of the specific circuits of FIGS. 2 and 3. Merely as an example, FIG. 2 illustrates a simplified detailed diagram of a circuit 6 which may be used to implement the block diagram of FIG. 1. A variety of components and component arrangements may be used to implement the functions set forth in FIG. 1. As shown in FIG. 2, a transistor 30 is provided with an input terminal 31 for connection to the output of an electro-acoustic transducer such as an electret based condenser microphone element. Transistor 30 may, for example, be a high input impedance MOSFET transistor. Where transistor 30 is an n-channel MOSFET, the source of transistor 30 is connected to a ground rail 56 of the circuit. A terminal 14 is coupled to ground rail 56. A current source 50 coupled to the drain of transistor 30 provides the necessary bias to transistor 30 via a power supply rail. The output signal of the circuit appears between the terminal 10 and terminal 14.

The circuit generally comprises a first gain stage comprising a transistor 44 and a second gain stage including an amplifier 48 and a transistor 46. Other gain configurations and components may also be used. Transistor 44 and transistor 46 may, for example, be npn bipolar junction transistors. Amplifier 48 may, for example, be an operation amplifier. Transistor 44 may provide the primary gain of the circuit to achieve a higher signal to noise ratio for the circuit. A resistor 32 is coupled to the emitter of transistor 44 and the ground rail 56. The output of transistor 44 V₀₁ is applied to a first input 47 of amplifier 48. The output of amplifier 48 is applied to the base of transistor 46. A terminal 16 is coupled to the emitter of transistor 44 to allow additional circuit components coupled to terminal 16 to modify the high pass frequency characteristics of the circuit at low frequencies.

Amplifier 48 and transistor 46 of the second gain stage form a non-inverted amplifier with an output V₀(f). A capacitor 40 is coupled between the source of transistor 30 and the ground rail 56. A capacitor 42 is coupled between the collector of transistor 46 and the ground rail 56. Capacitor 40 and capacitor 42 act to filter out low frequency radio frequency interference in the signal. Current sources 52 and 54 provide bias to transistor 44, amplifier 48, and transistor 46. Additional current sources may be provided as needed.

The collector of transistor 46 is coupled to terminal 10. A terminal 12 is coupled to a second input 45 to amplifier 48. A resistor 36 is coupled between terminal 10 and terminal 12. A resistor 38 is coupled between terminal 12 and ground rail 56. Resistor 38 may be, for example, an electrically adjustable zener-zap adjustable resistor or a zipper diffused adjustable resistor. Resistor 38 may have terminals leading external to circuit 6 or external to multifunction preamplifier microphone 2 to which a current may be applied to adjust the resistance of resistor 38 to achieve a desired configuration of multifunction preamplifier microphone 2. A resistor 34 is coupled between terminal 12 and ground rail 56 in parallel with resistor 34. Resistor 34, resistor 36, resistor 38 act as a filter for audio signals and may be utilized with additional circuit components coupled to terminal 12 to modify the filter low pass corner frequency and high pass corner frequency characteristics.

FIG. 3 illustrates a simplified detailed diagram of a system utilizing the multifunction preamplifier microphone of FIG. 1. Referring to FIG. 2 and FIG. 3, additional circuit components external to multifunction preamplifier microphone 2 may be used to configure the audio signal band pass filter characteristics and high pass frequency characteristics at low frequencies of multifunction preamplifier microphone 2. A D.C. supply voltage 70 is coupled to terminal 10 via a bias resistor 68. A capacitor 60 is coupled across terminal 10 and terminal 12. A capacitor 62 is coupled across terminal 12 and terminal 14. Terminal 14 is coupled to ground. An adjustable resistor 66 is coupled across terminal 12 and terminal 14 in parallel with capacitor 62. Adjustable resistor 66 may, for example, be an electrically adjustable zener zap or zipper diffused resistor, or a laser trimmable resistor. A capacitor 64 is coupled across terminal 16 and terminal 14 in parallel with resistor 32.

Capacitor 64 coupled between terminal 16 and terminal 14 may be used to configure the high pass frequency characteristics at low frequencies of multifunction preamplifier microphone 2. The gain of transistor 44 is inversely proportional to the value of capacitor 64 at low frequencies. Thus, the circuit has a configurable high pass frequency response with a corner frequency determined by the selection of capacitor 64.

Capacitor 60, capacitor 62, and adjustable resistor 66 may be used to configure the audio signal filter characteristics of multifunction preamplifier microphone 2. The output of transistor 46 V₀(f) may be expressed as:

$${V}_{0} ( f ) \approx [ 1 + \frac{{Z}_{1} ( f )}{{Z}_{2} ( f )} ]$$

where Z₁(f) is equal to (the value of resistor 36 in parallel with (1/j2πfC₆₀)) and where Z₂(f) is equal to (the value of resistor 34 in parallel with resistor 38 in parallel with resistor 66 in parallel with (1/j2πfC₆₂)). Z₁(f) and Z₂(f) may be expressed as:

$${Z}_{1} ( f ) = {R}_{36} \vert \vert \frac{1}{[ j2 π {fC}_{60} ]}$$

$${Z}_{2} ( f ) = {R}_{34} \vert \vert {R}_{38} \vert \vert {R}_{66} \vert \vert \frac{1}{[ j2 π {fC}_{62} ]}$$

where R₃₆ is equal to the value of resistor 36, C₆₀ is equal to the value of capacitor 60, R₃₄ is equal to the value of resistor 34, R₃₈ is equal to the value of resistor 38, R₆₆ is equal to the value of resistor 66, and C₆₂ is equal to the value of capacitor 62.

At audio signal frequencies, for example voice frequencies between 300 Hz and 4 kHz, capacitor 60 determines the low pass corner frequency and capacitor 62 determines the high pass corner frequency. The value of capacitor 60 and capacitor 62 may therefore be selectively adjusted to configure the circuit 6 filter characteristics. Modifying the value of capacitor 60 adjusts the corner frequency of the circuit 6 low pass characteristics. This may be done, for example, to compensate for the high frequency boost of a noise canceling microphone assembly or for noise reduction. Modifying the value of capacitor 62 adjusts the corner frequency of the circuit 6 high pass characteristics. This may be done, for example, to compensate for the high frequency loss of a voice tube microphone assembly or for high frequency emphasized headsets.

The gain of multifunction preamplifier microphone 2 may be adjusted through terminal 12 by modifying the value of adjustable resistor 66. The gain of the system may also be adjusted by modifying the value of resistor 38 using zener zap or zipper resistor adjustment techniques. In a further example circuit, either resistor 38 or adjustable resistor 66 is present, but not both.

Although FIG. 2 illustrates certain circuit components in multifunction preamplifier microphone 2 and certain circuit components external to multifunction preamplifier microphone 2, the location of particular electrical components may be varied. Furthermore, referring to FIG. 1, circuit components may be located external to circuit 6 while still internal to microphone preamplifier microphone 2.

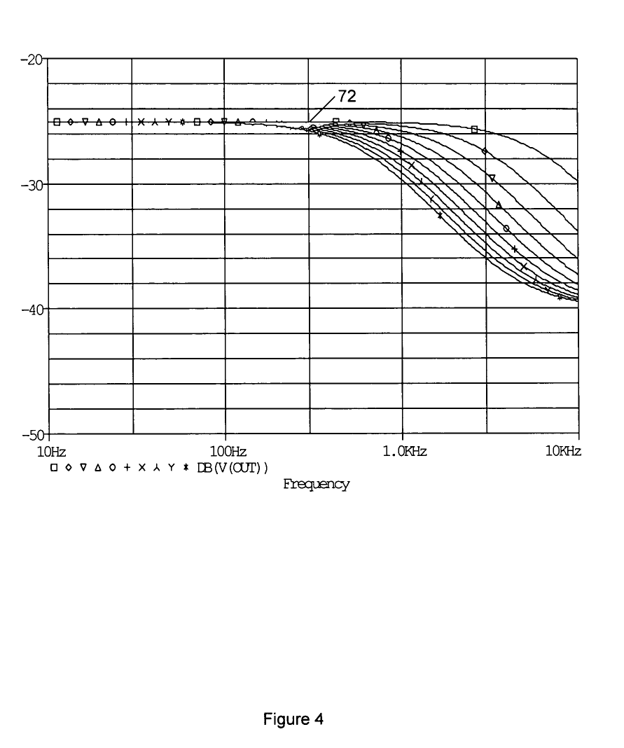

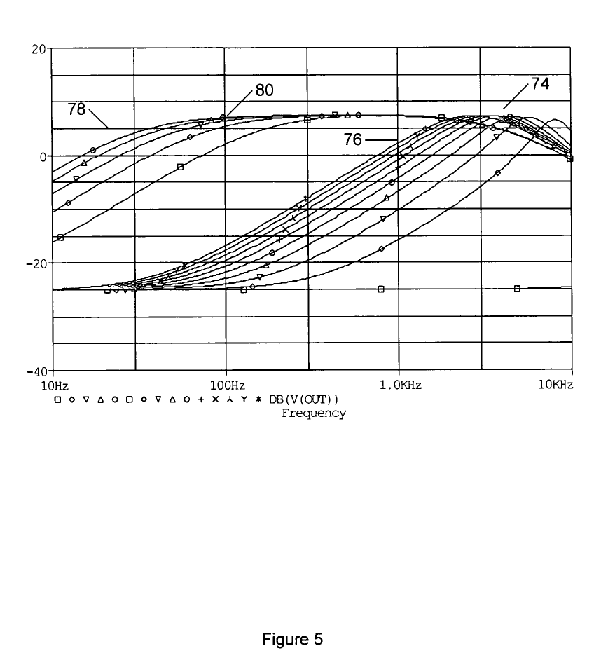

Referring to FIG. 4 and FIG. 5, configuration of the multifunction preamplifier microphone 2 is shown in test applications of the processes and systems described herein. In FIG. 4 and FIG. 5, gain in dB of the multifunction preamplifier microphone 2 is illustrated as a function of frequency. Referring to FIG. 4, in a test simulation the value of capacitor 60 can be selected to set a low pass corner frequency at a frequency 72 in a range of 500 Hz to 5000 Hz. Referring to FIG. 5, in a test simulation the value of capacitor 62 can be adjusted to obtain gain-frequency curves 74. The value of capacitor 62 can be selected, for example, to set a high pass corner frequency 76 in a range of 1000 Hz to 7000 Hz. In further reference to FIG. 5, in a test simulation the value of capacitor 64 can be adjusted to obtain gain-frequency curves 78. The value of capacitor 64 can be selected, for example, to set a high pass corner frequency 80 for low frequencies at 100 Hz.

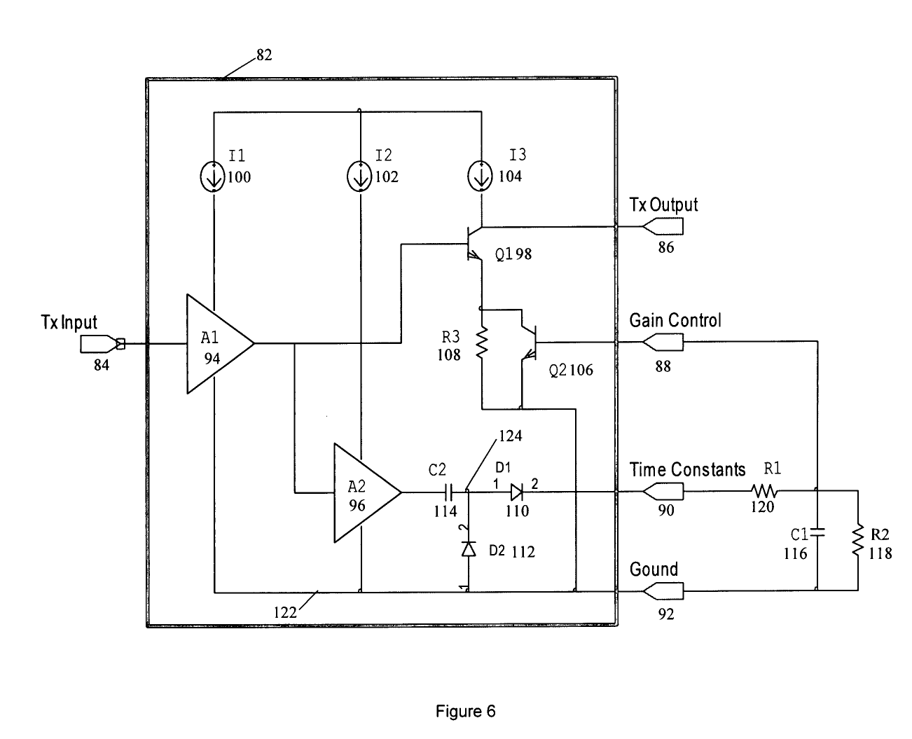

In a further example, the multifunction preamplifier microphone 2 may include a configurable voice expansion timing circuit which reduces background noise and provides a smooth noise to speech level transition. Merely as an example, FIG. 6 illustrates a simplified detailed diagram of a circuit 82 which may be used to implement a voice expansion timing circuit. Circuit 82 is implemented on an integrated circuit, for example. Circuit 82 may also be included as a part of circuit 6 described above in reference to FIG. 1 and FIG. 2. As shown in FIG. 6, an amplifier 94 is provided with an input terminal 84 for connection to the output of an electro-acoustic transducer such as an electret based condenser microphone element. Circuit 82 includes output terminal 86, gain control terminal 88, time constants terminal 90, and ground terminal 92 which provide connection to various locations of circuit 82. The output of amplifier 94 is applied to the input of a second amplifier 96. Amplifier 94 and amplifier 96 may, for example, be operational amplifiers.

The output of amplifier 94 is applied to the base of a transistor Q1 98. Current sources 100, 102, and 104 provide the necessary bias to amplifier 94, amplifier 96, and transistor Q1 98 respectively. The output signal of the circuit appears between the output terminal 86 and ground terminal 92.

The emitter of transistor Q1 98 is coupled to the collector of a transistor Q2 106 and the first end of a resistor R3 108. The emitter of transistor Q2 106 and the second end of resistor R3 108 are both coupled to a ground rail 122. The base of transistor Q2 106 is coupled to a gain control terminal 88. In operation, transistor Q1 98, transistor Q2 106, and resistor R3 108 may operate to selectively vary the gain of circuit 82 as a function of an input voltage Vᵢₙ received at an input terminal 84 as discussed in further detail below.

The output of amplifier 96 is coupled to the first end of a capacitor C2 114. The second end of capacitor C2 114 is coupled to a circuit point 124. The circuit point 124 is coupled to a first end of a diode 110. The second end of diode 110 is coupled to a resistor R1 120 through a time constants terminal 90. Time constants terminal 90 allows additional circuit components external to circuit 82 to be coupled to time constants terminal 90 to configure the time constants characteristics of circuit 82. A diode D2 112 is coupled between the ground rail 122 and circuit point 124. The ground rail 122 is coupled to ground terminal 92.

A resistor R2 118 is coupled between gain control terminal 88 and ground terminal 92 in parallel with a capacitor C1 116. A resistor R1 120 is coupled between time constants terminal 90 and gain control terminal 88. In the example circuit illustrated in FIG. 6, capacitor C1 116, resistor R1 120, and resistor R2 118 are coupled to circuit 82 terminals to selectively configure or modify the gain characteristics of circuit 82 depending on the input voltage Vᵢₙ.

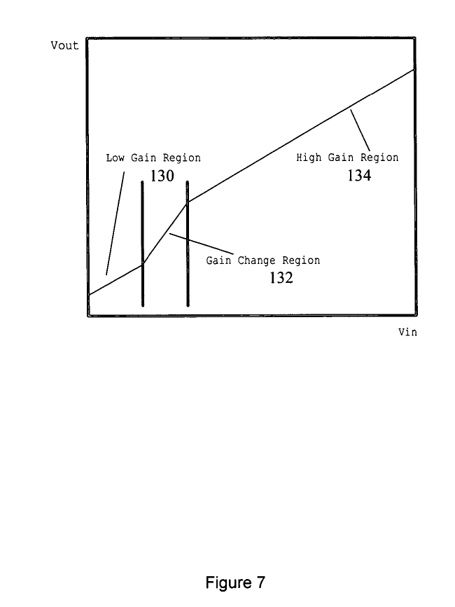

In operation, referring to FIG. 7, circuit 82 may provide an output voltage Vₒᵤₜ as a function of Vᵢₙ corresponding to a low gain region 130, gain change region 132, and high gain region 134. When Vᵢₙ is low, corresponding to ambient noise and no user voice signal, a voltage V_{c1} across capacitor C1 116 is zero or near zero and transistor Q2 106 is in cut-off mode. When Q2 106 is in cut-off mode, transistor Q1 98 sees resistor R3 108, which acts as a large current feedback resistor. The resulting gain of circuit 82 is low.

When Vᵢₙ is at a level in gain change region 132, corresponding to a quiet voice signal higher than the ambient noise level, the voltage V_{c1} across capacitor C1 116 rises so that transistor Q2 106 is turned on. When transistor Q2 106 is turned on, transistor Q1 98 sees a current feedback resistance equal to the value of resistor R3 108 in parallel with the collector to emitter impedance of transistor Q2 106. The resulting gain of circuit 82 increases. The charging time constant is controlled by resistor R3 108 multiplied by capacitor C1 116. For example, resistor R3 108 may have a value of one kilo-ohm. When Vᵢₙ is at a level in high gain region 134, corresponding to a normal speech signal, the voltage V_{c1} across capacitor C1 116 is at its highest level resulting in transistor Q2 106 operating in saturation mode. During operation of transistor Q2 106 in saturation mode, transistor Q1 98 sees a current feedback resistance equal to the collector to emitter impedance of transistor Q2 106. The resulting gain of circuit 82 is high. For example, the collector to emitter impedance of transistor Q2 106 may be less than 100 ohms. When Vᵢₙ drops lower than a level corresponding to a normal speech level signal, the voltage V_{c1} across capacitor C1 116 is discharged and the resulting gain of circuit 82 decreases. The discharging time constant is controlled by resistor R2 118 multiplied by capacitor C1 116. As a result, circuit 82 provides for lowered background noise and a smooth noise to speech level transition.

For example, the circuit 82 may be used with linear omni-directional microphones which are prone to picking up undesirable ambient noise. When the voice expansion functionality is added to microphones used in close talk devices, background noise can be reduced during non-speech periods. For example, a typical reduction of gain during non-speech periods may be 12 dB. In situations with a reasonable signal to background noise ratio, the non-speech periods are when background noise is most apparent. Additionally, in telephone applications where side tone directs local microphone signals to the user's own receiver, reduction of sidetone-produced background noise is achieved with circuit 82. For example, attack time constants may be chosen to capture beginnings of words effectively, such as 5 to 15 milliseconds. Release times may be set to allow for slight pauses, such as 60 to 200 milliseconds.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A microphone comprising:
a microphone transducer;
a configurable preamplifier circuit coupled to the microphone transducer comprising:
an output terminal for outputting a signal; and
a configuration terminal for coupling one or more circuit components to the preamplifier circuit; and
a housing containing the microphone transducer and configurable preamplifier circuit.

2. The microphone of claim 1, wherein the configurable preamplifier circuit is disposed on an integrated circuit.

3. The microphone of claim 1, wherein the configurable preamplifier circuit further comprises one or more of the following: a configurable high pass filter for audio signals, a configurable low pass filter for audio signals, and a configurable high pass filter for low frequency signals.

4. The microphone of claim 3, wherein the low frequency signals are associated with hum noise or wind noise.

5. The microphone of claim 1, wherein a gain of the microphone is adjustable through the configuration terminal.

6. The microphone of claim 1, wherein the configurable preamplifier circuit further comprises one or more components for a voice expansion timing circuit.

7. The microphone of claim 1, wherein the configurable preamplifier circuit further comprises a filter for radio frequency interference.

8. The microphone of claim 1, wherein the output terminal and the configuration terminal extend out of the housing for coupling the configurable preamplifier circuit to one or more circuit components disposed outside the housing.

9. The microphone of claim 1, wherein the configurable preamplifier circuit further comprises:
an electrically adjustable resistor; and
a resistor adjustment terminal for applying electrical energy to adjust the electrically adjustable resistor.

10. The microphone of claim 9, wherein the resistor adjustment terminal extends out of the housing.

11. The microphone of claim 1, wherein the microphone transducer is an electret condenser element.

12. The microphone of claim 1, wherein the configurable preamplifier circuit further comprises:
a first stage amplifier comprising a first transistor; and
a second stage amplifier comprising an operational amplifier and a second transistor.

13. A microphone comprising:
a microphone transducer;
an integrated circuit coupled to the microphone transducer comprising:
a preamplifier circuit;
an output terminal;
one or more configuration terminals through which additional circuit components may be connected to the pre-amplifier circuit to modify operation of the preamplifier circuit;
a microphone housing for holding the microphone transducer and integrated circuit, the microphone housing providing access to the output terminal and one or more configuration terminals.

14. The microphone of claim 13, wherein the preamplifier circuit comprises circuit components for one or more of the following: a configurable high pass filter for audio signals, a configurable low pass filter for audio signals, and a configurable high pass filter for low frequency signals.

15. The microphone of claim 13, wherein the low frequency signals are associated with hum noise or wind noise.

16. The microphone of claim 13, wherein the preamplifier circuit further comprises circuit components for a radio frequency interference filter.

17. The microphone of claim 13, wherein the preamplifier circuit further comprises an electrically adjustable resistor and the integrated circuit further comprises a resistor adjustment terminal for applying electrical energy to adjust the electrically adjustable resistor.

18. The microphone of claim 17, wherein the microphone housing provides access to the resistor adjustment terminal.

19. The microphone of claim 13, wherein the preamplifier circuit further comprises:
a first stage amplifier comprising a first transistor; and
a second stage amplifier comprising an operational amplifier and a second transistor.

20. The microphone of claim 13, wherein the preamplifier circuit further comprises circuit components for a voice expansion timing circuit.

21. A microphone comprising:
a transducer means for converting a speech signal into an electrical signal;
a configurable preamplifier circuit means for amplifying and processing the speech signal coupled to the transducer means, the preamplifier circuit means comprising:
an output means for outputting an amplified and processed electrical signal; and
a configuration means for coupling one or more circuit components to the configurable preamplifier circuit means; and
a means for holding the transducer means and configurable preamplifier circuit means.

22. The microphone of claim 21, wherein the configurable preamplifier circuit means further comprises one or more of the following: a configurable high pass filter means for filtering audio signals, a configurable low pass filter means for filtering audio signals, and a configurable high pass filter means for filtering low frequency signals.

23. The microphone of claim 22, wherein the low frequency signals are associated with hum noise or wind noise.

24. The microphone of claim 21, wherein a gain of the microphone is adjustable through the configuration means.

25. The microphone of claim 21, wherein the configurable preamplifier circuit means further comprises a radio frequency interference filter means for filtering radio frequency interference.

26. The microphone of claim 21, wherein the configurable preamplifier circuit means further comprises:
an electrically adjustable resistance means for providing a variable resistance; and
a resistor adjustment means for applying electrical energy to adjust the electrically adjustable resistance means.

27. The microphone of claim 21, wherein the configurable preamplifier circuit means further comprises a voice expansion timing means for providing a variable gain as a function of input voltage.
